(19) United States
(12) Patent Application Publication
(10) Pub. No.: US 2017/0089321 A1
(43) Pub. Date: Mar. 30, 2017

(54) APPARATUS FOR GENERATING ELECTRICITY FROM A TIDAL OR OCEAN CURRENT WATER FLOW

(71) Applicant: Ocean Current Energy LLC, London (GB)

(72) Inventor: Patrick James Mulvey, San Diego, CA (US)

(21) Appl. No.: 15/126,414

(22) PCT Filed: Mar. 12, 2015
(86) PCT No.: PCT/GB2015/000088

§ 371 Date: Sep. 15, 2016

(30) Foreign Application Priority Data
Mar. 18, 2014 (GB) 1404884.7

(51) Int. Cl. F03B 15/00; H02K 7/18; F03B 17/06; F03B 13/26; F03B 13/10

(52) U.S. Cl. CPC F03B 15/00; F03B 13/264; F03B 13/10; F03B 17/061; H02K 7/1823

(57) ABSTRACT

Apparatus (2) for generating electricity from a tidal or ocean current water flow, which apparatus (2) comprises: • a plurality of electrical generators (4) for generating electricity; and • each electrical generator (4) comprises a rotor (8), a stator (10), and a housing (12); • the housing (12) is a multi-sided housing constructed such that the electrical generators (4) are stably connected together; • the apparatus (2) includes positioning means (20) for positioning the apparatus (2) above a waterbed (22); and • the apparatus (2) includes position-adjusting means (24) for adjusting the height and/or the direction of the housing (12) such that the housing (12) is always able to be at a height and pointing in a direction for receiving maximum flow of water through the housing (12), and thereby to enable the apparatus (2) to generate a maximum amount of electricity from the water flow.

This invention relates to apparatus for generating electricity and, more especially, this invention relates to apparatus for generating electricity from a tidal or ocean current water flow.

There are many different types of known apparatus for generating electricity from a tidal or ocean current water flow. The water may be sea water or river water. Tides or ocean currents cause the water to flow, and it is this flow which is used by the apparatus in order to generate the electricity. In deep waters, the known apparatus may not be positioned at a height and/or in a direction for enabling the apparatus to receive the maximum available water flow.

It is an aim of the present invention to reduce the above mentioned problem.

Accordingly, in one non-limiting embodiment of the present invention there is provided apparatus for generating electricity from a tidal or ocean current water flow, which apparatus comprises:
(i) a plurality of electrical generators for generating electricity; and
(ii) connection means for electrically connecting the electrical generators together such that the generated electricity is able to be directed to wherever desired;
   and the apparatus being characterised in that:
(iii) each electrical generator comprises a rotor, a stator, and a housing;
(iv) the housing is a multi-sided housing constructed such that the electrical generators are stably connected together;
(v) the housing is open at both ends so that the water can flow in either direction through the housing;
(vi) the rotor is rotated by vanes, and the vanes are inside the housing;
(vii) the apparatus includes positioning means for positioning the apparatus above a waterbed; and
(viii) the apparatus includes position-adjusting means for adjusting the height and/or the direction of the housing such that the housing is always able to be at a height and pointing in a direction for receiving maximum flow of water through the housing, and thereby to enable the apparatus to generate a maximum amount of electricity from the water flow.

The apparatus of the present invention is advantageous in that the housings of the electrical generators are easily connectable together in a stable manner. Also, the housings enable the electrical generators to be easily separated such that replacement of a separate housing in the event of a malfunction is easily effected. Further, the position-adjusting means enables the housing always to be at a height and pointing in a direction for receiving maximum flow of water through the housing, and thereby to enable the apparatus to generate a maximum amount of electricity from the water flow. The provision of the position-adjusting means is especially advantageous in water flows which may be deep and with the maximum water flow being positioned somewhere between the top and bottom of the water, and possibly varying in depth due to environmental conditions. Similarly, the direction of the water flow in relation to the housing in the apparatus of the present invention may vary due to environmental conditions. In known types of apparatus for generating electricity, the apparatus is usually static, for example positioned on a waterbed. In such cases, the housing may miss the maximum water flow due to the apparatus being positioned at an incorrect height and/or facing in an incorrect direction.

The apparatus may be one in which the position-adjusting means includes height adjusting means for adjusting the height of the apparatus above a waterbed.

The height adjusting means may comprise a first cable which is vertically positioned, and first control means for controlling the length of the first cable. The first control means may be an electrical, hydraulic or pneumatic drive motor. Other types of height adjusting means may be employed.

The apparatus may be one in which the positioning means comprises a plurality of second cables which extend at angles to the waterbed and which maintain the first cable vertically positioned. The second cables may be controlled by second control means. The second control means may be of the same type as the first control means. Other types of positioning means may be employed.

The apparatus may include at least one sensor means for detecting the height of the water at which the maximum water flow is occurring and/or the direction of approach of the maximum water flow relative to the housing. Signals from the sensor means may be used to operate the first and/or the second control means. The first and second control means may be integrated into a single control unit, for example a single drive means such for example as a drive motor.

The apparatus may be one in which:
(i) the rotor comprises a plurality of magnets positioned around the periphery of the rotor;
(ii) the magnets are encased in a protective material which protects the magnets from the water; and
(iii) the vanes are positioned on the rotor.

If desired, other types of electrical generator may be employed. Thus, for example, the vanes may be positioned inside the housing, and the electrical generator may be positioned outside the housing. In this case a rotatable drive arrangement may be employed for transferring rotation of the vanes to rotation of the rotor.

The magnets may be located in pockets. Each magnet may have its own pocket. However, if desired, two or more magnets may be located in a single pocket.

The protective material may be sheet material. Other protective materials such for example as mastic material may be employed.

Where the protective material is a sheet material, then the sheet material is preferably a para-aramid synthetic fibre, for example Kevlar (Registered Trade Mark).

The apparatus may be one in which the stator is positioned inside the housing. Alternatively, if desired, the stator may be positioned outside the housing.

The positioning means may include buoyancy means. The buoyancy means may comprise at least one air tank.

When the apparatus of the present invention is positioned in a sea, then the waterbed will be a sea bed. When the apparatus of the present invention is positioned in a river or strait, then the waterbed will be a river bed.

Embodiments of the invention will now be described solely by way of example and with reference to the accompanying drawings in which:

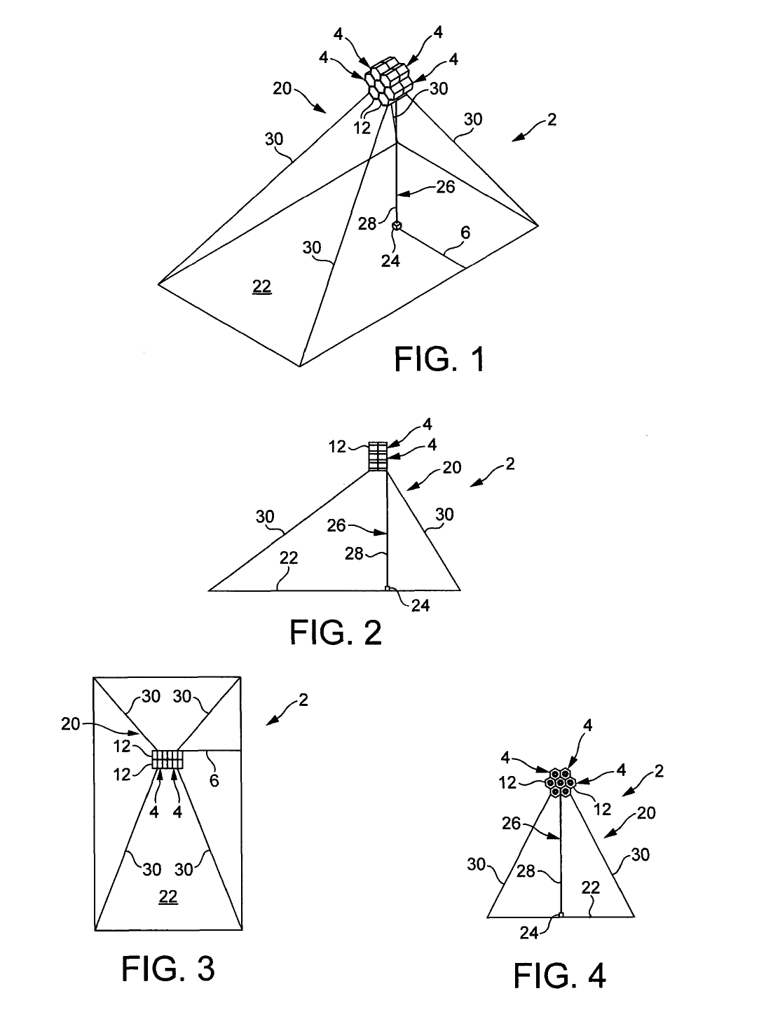

FIG. 1 is a perspective view of first apparatus of the present invention;

FIG. 2 is a side view of the apparatus shown in FIG. 1;

FIG. 3 is top plan view of the apparatus shown in FIG. 1;

FIG. 4 is an end view of the apparatus shown in FIG. 1;

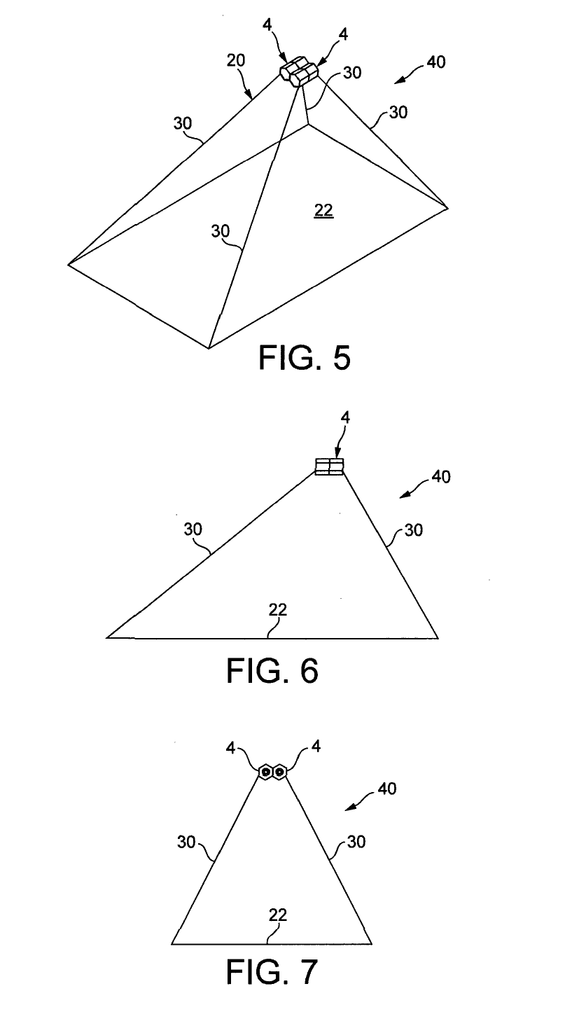

FIG. 5 is a perspective view of part of second apparatus of the present invention;

FIG. 6 is a side view of the apparatus as shown in FIG. 5;

FIG. 7 is an end view of the apparatus as shown in FIG. 5;

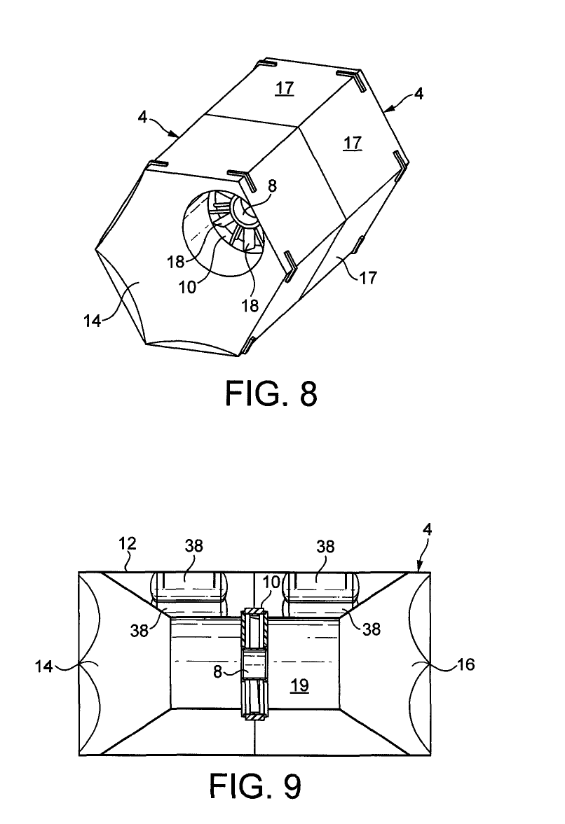

FIG. 8 is a perspective view of an electrical generator used in the apparatus of the present invention;

FIG. 9 is a longitudinal section through the electrical generator as shown in FIG. 8;

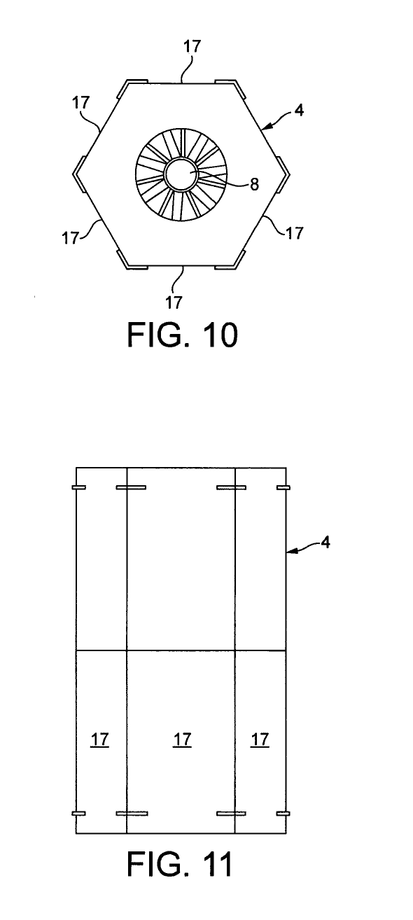

FIG. 10 is an end view of the electrical generator as shown in FIG. 8;

FIG. 11 is a top view of the electrical generator shown in FIG. 8;

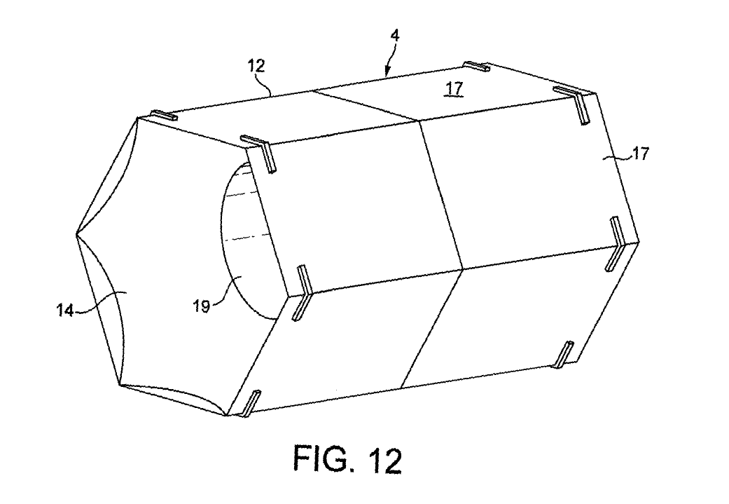

FIG. 12 is an enlarged view of a housing forming part of the electrical generator shown in FIG. 8;

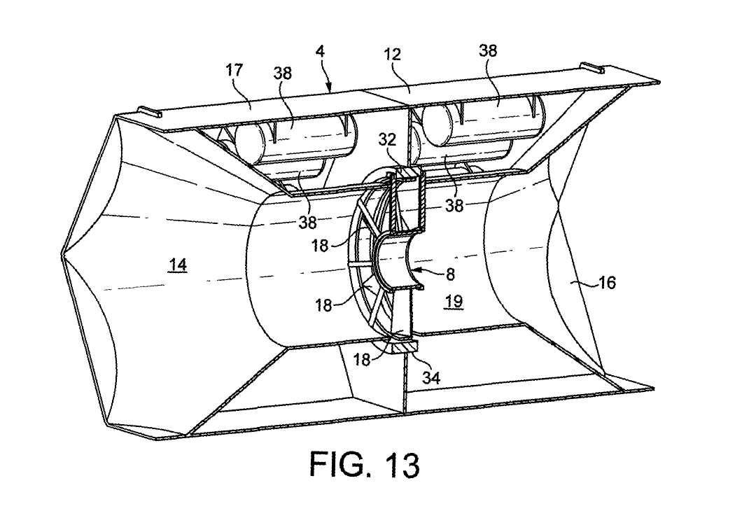

FIG. 13 is an enlarged perspective part-sectional view of the apparatus as shown in FIG. 9;

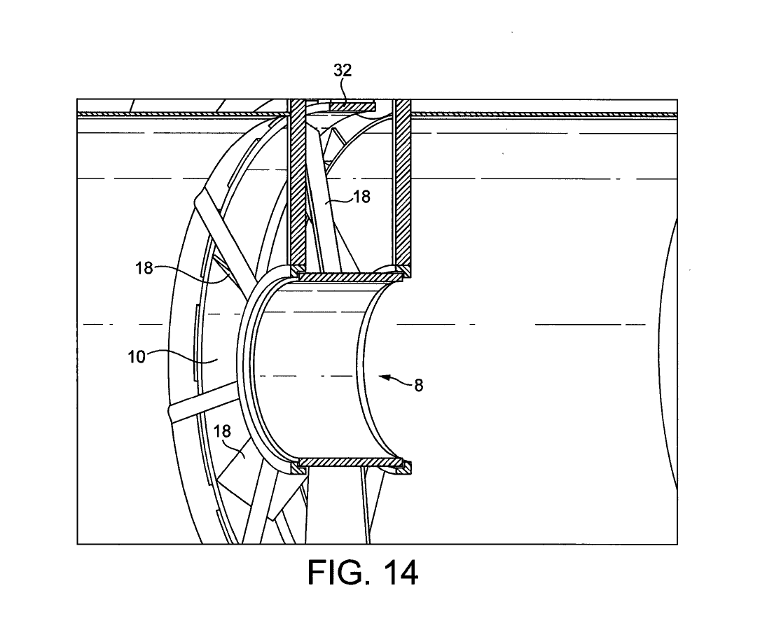

FIG. 14 is an enlarged view of a rotor and stator part of the electrical generator as shown in FIG. 13;

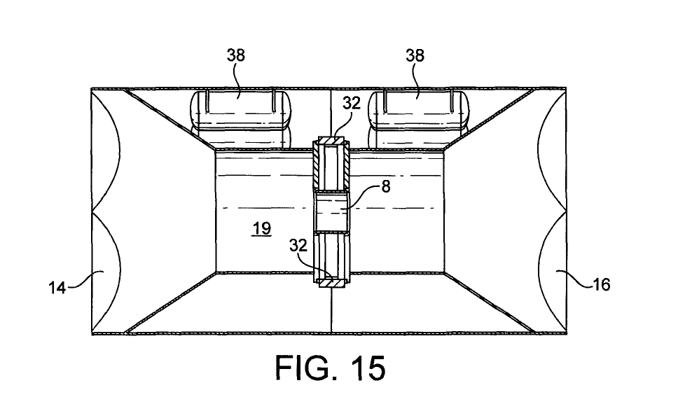

FIG. 15 is an enlarged view of the electrical generator as shown in FIG. 13; and

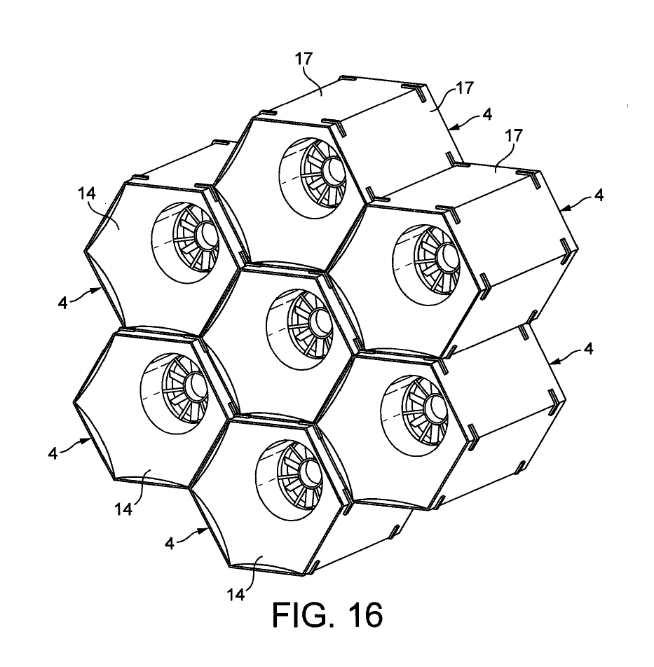

FIG. 16 is a perspective view of connected electrical generators as shown in the apparatus shown in FIG. 1.

Referring to FIGS. 1-4, there is shown first apparatus 2 for generating electricity from a tidal or ocean current water flow. The apparatus 2 comprises a plurality of electrical generators 4 for generating electricity. The apparatus 2 also comprises connection means 6 for electrically connecting the electrical generators 4 together such that the generated electricity is able to be directed to wherever desired.

Each electrical generator 4 comprises a rotor 8, a stator 10 and a housing 12. The housing 12 is a multi-siding housing 12 constructed such that the electrical generators 4 are stably connectable together. This stable connection of the electrical generators 4 is best appreciated from FIG. 16.

As shown in FIGS. 8-15, each electrical generator 4 is such that the housing 12 is open at both ends 14, 16 so that the water can flow in either direction through the housing 12. The rotor 8 is rotated by vanes 18 inside the housing 12. The housing 12 has flat sides 17 and a parallel sided tubular portion 19.

The apparatus 2 includes positioning means 20 for positioning the apparatus 2 above a waterbed 22.

The apparatus 2 further includes position-adjusting means 24. The position-adjusting means 24 is for adjusting the height and/or the direction of the housing 12 such that the housing 12 is always able to be at a height and pointing in a direction for receiving a maximum flow of water through the housing 12. This thereby enables the apparatus 2 to generate a maximum amount of the electricity from the water flow.

The position-adjusting means 24 includes height-adjusting means 26 for adjusting the height of the apparatus 2 above the waterbed 22. The height adjusting means 26 comprises a first cable 28 which is vertically positioned. The height adjusting means 26 may include first control means (not shown) for controlling the length of the first cable. By way of example, it is mentioned that the apparatus 2 may be positioned in water up to 400 m in depth, and at a height of 50 m above the waterbed.

The positioning means 20 is a plurality of second cables 30 which extend at angles to the waterbed 22 and which maintain the first cable 28 vertically positioned. The positioning means 20 may include second control means (not shown) for controlling the second cables 30.

The apparatus 2 includes at least one sensor means for detecting the height of the water at which maximum water flow is occurring and/or the direction of approach of the maximum water flow relative to the housing 12.

The first and second control means may be in the form of a single drive means which operates consequent upon signals from the sensor means to adjust the position of the housing 12 to the required height and/or direction for receiving the maximum flow of the water through the housing 12.

The apparatus 2 is one in which the rotor 8 comprises a plurality of magnets 32 positioned around the periphery of the rotor 8. The magnets 32 are encased in a protective material 34 which protects the magnets 32 from the water. The vanes 18 are positioned on the rotor 8. The magnets 32 are located in pockets. Each magnet 32 has its own pocket. The protective material 34 is sheet material in the form of Kevlar. The stator 10 is inside the housing 12.

The apparatus 2 is such that the positioning means 20 includes buoyancy means in the form of four air tanks 38.

The housing 12 is multi-sided as shown. This enables the electrical generators 4 to be stably connected together as shown in FIGS. 1-4 and 16. This stable connection together of the electrical generators 4 is especially important since the apparatus 2 is floating above the waterbed 22 and there will be forces on the apparatus 2 as it is held in position by the cables 28, 30 against the water flow. The apparatus 2 is able to be positioned at exactly the right height and facing exactly the right direction for receiving the maximum water flow. This is much more advantageous than mounting the apparatus 2 on the waterbed 22, which may be, for example 80 metres deep, with maximum water flow occurring at perhaps 30 metres deep.

The electrical generators may be easily constructed. Each stator may comprise a coil, for example a copper wire coil, suitably protected against corrosion from the water.

Referring now to FIGS. 5-7, there is shown part of second apparatus 40 which is like the apparatus 2. Similar parts as in the apparatus 2 have been given the same reference numerals for ease of comparison and understanding.

The apparatus 40 is such that only two of the electrical generators 4 are connected together. The electrical generators 4 may be regarded as acting as turbines. For ease of illustration, the connection means 6 and the position-adjusting means 24 have been omitted from FIGS. 5-7.

The provision of the buoyancy means in the form of the air tanks 38 is advantageous in that the apparatus of the present invention has the required buoyancy to enable it to float as illustrated in FIGS. 1-4 on the one hand, and in FIGS. 5-7 on the other hand. The buoyancy is also advantageous in that if one of the electrical generators 4 should need to be repaired, then the electrical generator 4 can be removed from the remainder of the electrical generators 4 and floated to the surface for replacement or repair as appropriate.

It is to be appreciated that the embodiments of the invention described above with reference to the accompanying drawings have been given by way of example only and that modifications may be effected. Thus, for example, the housing may have more or less than six flat sides. The apparatus may be used in seas, rivers, straits and estuaries. Individual components shown in the drawings are not limited to use in their drawings and they may be used in other drawings and in all aspects of the invention.

1. Apparatus for generating electricity from a tidal or ocean current water flow, which apparatus comprises:
(i) a plurality of electrical generators for generating electricity; and
(ii) connection means for electrically connecting the electrical generators together such that the generated electricity is able to be directed to wherever desired;
and the apparatus being characterised in that:
(iii) each electrical generator comprises a rotor, a stator, and a housing;
(iv) the housing is a multi-sided housing constructed such that the electrical generators are stably connected together;
(v) the housing is open at both ends so that the water can flow in either direction through the housing;
(vi) the rotor is rotated by vanes, and the vanes are inside the housing;
(vii) the apparatus includes positioning means for positioning the apparatus above a waterbed; and
(viii) the apparatus includes position-adjusting means for adjusting the height and/or the direction of the housing such that the housing is always able to be at a height and pointing in a direction for receiving maximum flow of water through the housing, and thereby to enable the apparatus to generate a maximum amount of electricity from the water flow.

2. Apparatus according to claim 1 in which the position-adjusting means includes height-adjusting means for adjusting the height of the apparatus above a waterbed.

3. Apparatus according to claim 2 in which the height adjusting means comprises a first cable which is vertically positioned, and first control means for controlling the length of the first cable.

4. Apparatus according to claim 1 in which the positioning means comprises a plurality of second cables which extend at angles to the waterbed and which maintain the first cable vertically positioned.

5. Apparatus according to claim 4 in which the positioning means includes second control means for controlling the second cables.

6. Apparatus according to claim 1 and including at least one sensor means for detecting the height in the water at which maximum water flow is occurring and/or the direction of approach of the maximum water flow relative to the housing.

7. Apparatus according to claim 5 and including drive means which operates consequent upon signals from the sensor means to adjust the length of the housing and/or direction of the housing for receiving the maximum flow of the water through the housing.

8. Apparatus according to claim 1 in which:
(i) the rotor comprises a plurality of magnets positioned around the periphery of the rotor;
(ii) the magnets are encased in a protective material which protects the magnets from the water; and
(iii) the vanes are positioned on the rotor.

9. Apparatus according to claim 8 in which the magnets are located in pockets.

10. Apparatus according to claim 9 in which each magnet has its own pocket.

11. Apparatus according to claim 8 in which the protective material is sheet material.

12. Apparatus according to claim 11 in which the sheet material is Kevlar.

13. Apparatus according to claim 1 in which the stator is positioned inside the housing.

14. Apparatus according to claim 1 in which the positioning means includes buoyancy means.

15. Apparatus according to claim 14 in which the buoyancy means comprises at least one air tank.
